(19) United States
(12) Patent Application Publication
(10) Pub. No.: US 2009/0132633 A1
(43) Pub. Date: May 21, 2009

(54) DYNAMIC CONTENT PIPELINE

(75) Inventors: Christopher Jaffe, San Mateo, CA (US); Michael Mcelligott, San Francisco, CA (US); Ronald Martinez, San Francisco, CA (US); Joseph O'Sullivan, Oakland, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/943,122

(22) Filed: Nov. 20, 2007

(51) Int. Cl. G06F 15/16

(52) U.S. Cl. 709/201

(57) ABSTRACT

A system for providing information via a dynamic content pipeline includes a processor having instructions and a network interface in communication with the processor. The instructions configure the processor to display a media element on a display device of a computer, display a dispatcher link on the display device of the computer and display a dispatcher window on the display device of the computer when the dispatcher link is selected. The dispatcher window has a destination input area configured to receive a destination identifier which provides the location of a destination device. Finally, the instructions configure the processor to provide the media element to the dynamic content pipeline for additional processing and deliver the media element to the destination device.

### BACKGROUND OF THE INVENTION

1. Field of the Invention

The invention relates to systems and methods for providing information via a dynamic content pipeline.

2. Description of the Known Technology

Users have long experienced electronic content, such as web based advertisements, in passive ways. An example of passive content, or passively experienced content, is an advertisement with text and graphics displayed on a web page with other information in response to a user request. Increasingly, users also process that content, or wish to experience and use that content in contexts other than that with which the content was originally presented. Essentially, one drawback to passive content, such as a web based advertisement, is that if a user wishes to later access that content, the user may have some difficulty because the content may be inaccessible or very difficult to find.

Additionally, current methods of capturing content for further processing are not systematized or fail to deliver significant user value. Frequently, the user must have some technical facility to capture the content, such as a web based advertisement for further processing. An example of this would be cutting and pasting or downloading the content to a local client device only to later upload the same content to another location. Therefore, there is a need for an improved system and method for providing information via a dynamic content pipeline that overcomes the drawbacks of the prior art.

### BRIEF SUMMARY OF THE INVENTION

In overcoming the enumerated drawbacks and other limitations of the known technology, the present invention provides a system and method for providing information via a dynamic content pipeline. The system includes a processor having instructions and a network interface in communication with the processor. The instructions configure the processor to display a media element on a display device of a computer, display a dispatcher link on the display device of the computer and display a dispatcher window on the display device of the computer when the dispatcher link is selected. The dispatcher window has a destination input area configured to receive a destination identifier which provides the location of a destination device. Finally, the instructions configure the processor to provide the media element to the dynamic content pipeline for additional processing and deliver the media element to the destination device.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a block diagram of a system for providing information via a dynamic content pipeline;

FIG. 2 is a block diagram of a server shown in FIG. 1;

FIG. 3 is a screen capture of a media element;

FIGS. 4-6 are screen captures of a dispatcher window;

FIGS. 7 and 8 are an example of a media element delivered to a destination device;

FIG. 9 is a method for providing information via a dynamic content pipeline; and

FIG. 10 is a method illustrating additional processing which occurs in the dynamic content pipeline.

### DETAILED DESCRIPTION OF THE INVENTION

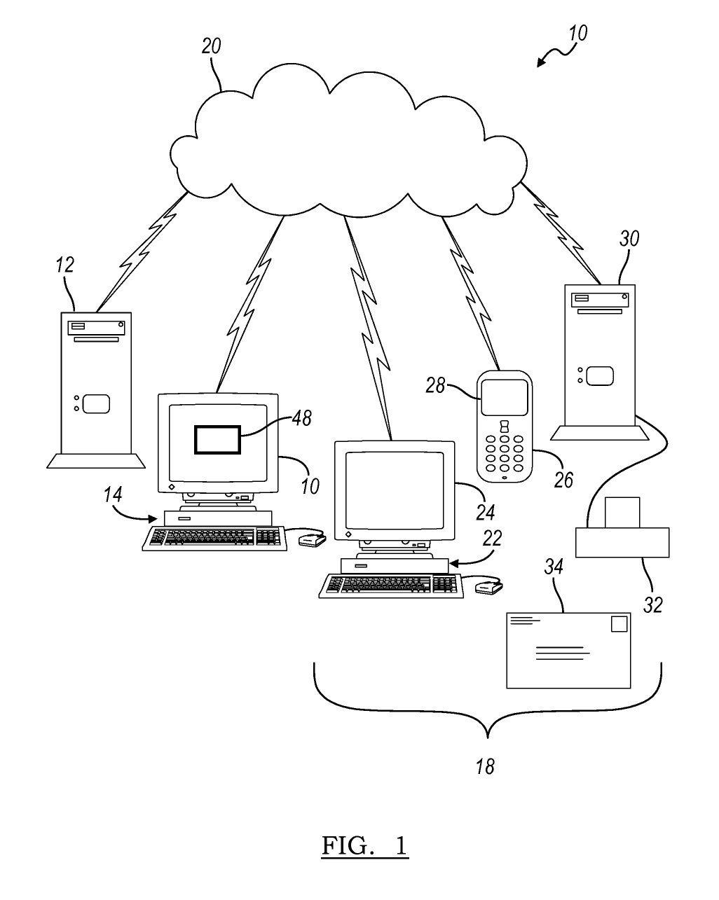

Referring to FIG. 1, a system 10 for providing information via a dynamic content pipeline is shown. The system 10 generally includes a server 12, a client computer 14 having a display device 16, and a destination device 18. The server 12, client computer 14, and destination device 18 are in communication with one another via a network 20. Preferably, the network 20 is a distributed network such as the Internet. Connections between devices may be wire line connections or wireless connections, or combinations of the two.

The destination device 18 may be any one of a number of different destination devices. For example, the destination device 18 may be a general purpose computer 22 having a display device 24. Generally, the general purpose computer 22 is connected to the network 20 and is capable of accessing the Internet and receiving e-mails, instant messages, and other forms of electronic communication. The destination device 18 may also be a mobile device 26 such as a mobile phone, personal digital assistant, or any other form of mobile device having a display area 28 for displaying text and graphics. Like the general purpose computer 22, the mobile device 26 is in communication with the network 20 and is capable of receiving at least one of e-mails, instant messages, or other forms of electronic communication. The destination device 18 may also be a server 30 capable of relaying a message to a printing device 32, such as a laser printer or inkjet printer. The printing device 32 is capable of printing a physical mailer 34 that can be delivered to a physical mail address. Finally, the destination device 18 may be GPS/navigation system of an automobile or even a smart appliance. A smart appliance is machine designed for a specific function that also has a built-in Web-enabled computer. Examples of smart appliances would include diverse products such as Web-enabled refrigerators and microwaves.

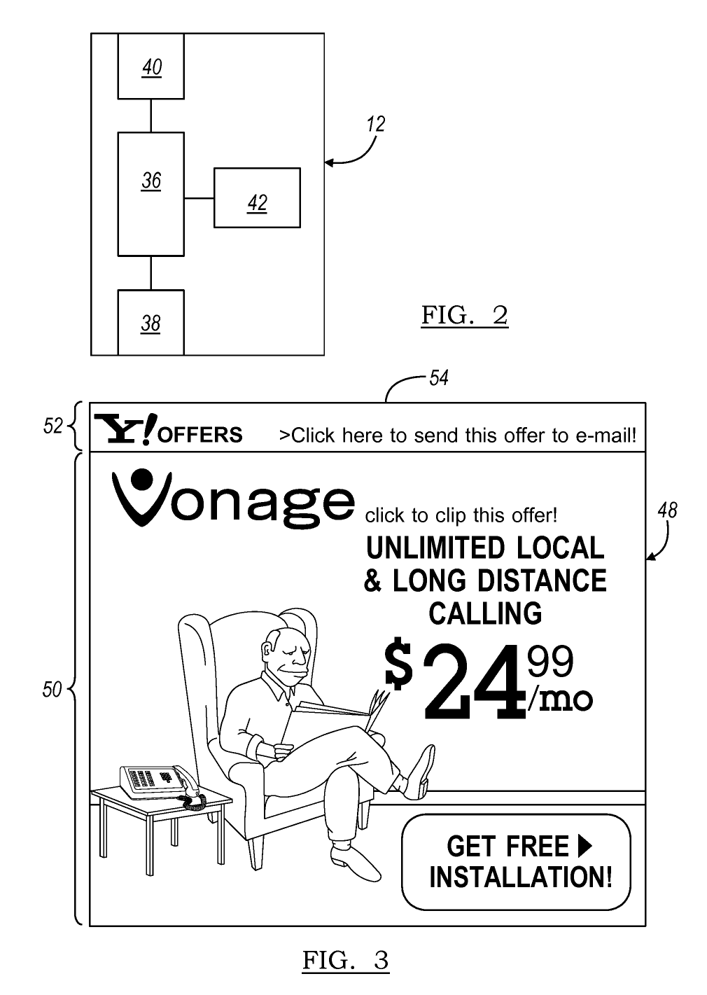

Referring to FIG. 2, a block diagram of the server 12 is shown. The server 12 includes a processor 36 in communication with a memory unit 38 and a network interface 40. The memory unit 38 contains instructions for configuring the processor to execute methods which will be described in the paragraphs that follow. The network interface 40 allows the processor 36 to communicate with the network 20 of FIG. 1. The processor 36 may also be in communication with one or more storage devices 42. As is well known, servers generally have a plethora of different storage devices such as magnetic storage devices, optical storage devices, or any storage device suitable of storing electronic information.

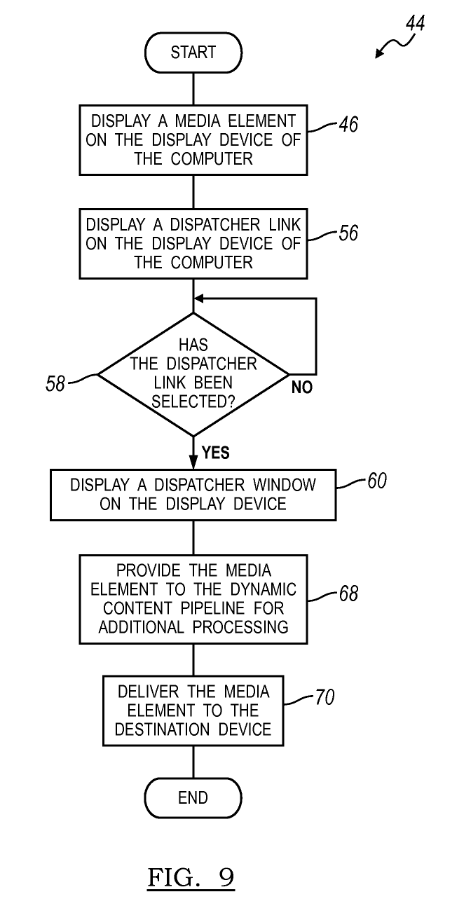

Referring to FIGS. 1, 3, and 9, a method 44 for providing information via a dynamic content pipeline will be described. The method 44 begins, as shown in step 46, with displaying a media element 48 oh a display device 16 of the client computer 14. The media element 48 may be any kind of electronic media such as those displayed in a web browser. Generally, however, the media element 48 contains a first section 50 displaying a web based advertisement. A second section 52 is generally a banner that runs on or near the periphery of the media element 48. However, it should be understood that the second section 52 can be located anywhere within the media element 48. Additionally, the second section 52 may be a pop up that is displayed in reaction to an input from a user.

In step 56, a dispatcher link 54 is displayed in a portion of the second section 52 of the media element 48. Generally, the dispatcher link 54 is a user selectable icon. Additionally, it should be understood that steps 46 and 56 may occur simultaneously. In other words, the dispatcher link 54 may be displayed as soon as the media element 48 is displayed on the display device 16 of the client computer 14.

In step 58, a determination is made if the dispatcher link 54 has been selected by a user of the client computer 14. Generally, the dispatcher link 54 is selected by using an analog cursor device, such as a mouse, as is well known in the art. If the dispatcher link 54 is not selected, the method 44 returns to step 58. Otherwise, as shown in step 60, a dispatcher window is displayed on the display device 16 of the client computer 14.

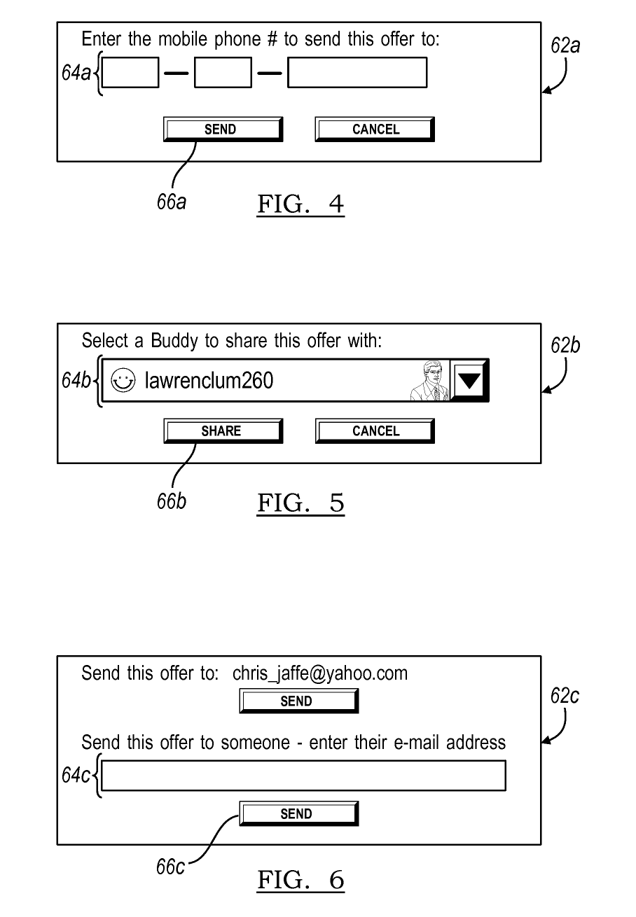

Referring to FIGS. 4, 5, and 6, different embodiments of the dispatcher window 62a, 62b, and 62c are shown. The dispatcher window 62a generally includes an area 64a for entering in a phone number to forward the media element 48 of FIG. 3 to. As will be described later, the media element 48 will receive additional processing by a dynamic content pipeline so as to improve the experience of a user of the destination device 18. As shown in the area 64a, the area 64a includes an area for entering a mobile phone so as to properly identify the destination device 18 to which the later dynamically content process media element 48 will be sent to. Dispatcher window 62b also includes an area 64b. As is noted, the area 64b includes a space for entering an instant messaging address of a user of a destination 18. Similarly, the dispatcher window 62c also includes an area 64c for entering an e-mail address of a user of a destination device 18. As is shown in the dispatcher windows 62a, 62b, and 62c, a send icon 66a, 66b, and 66c will send the media element 48 to the intended destination device 18.

The choice of whether to enter a phone number, email, or instant messaging address can be selected by the user viewing the dispatcher window or can be selected by an outside system, such as the server 12. For example, if the person using the destination device prefers to receive emails as opposed to instant messages, the outside system can be configured so as only forward the media element based on the preference of the person using the destination device. This preference may be selected by the user of the destination device or may be determined by the outside system. Additionally, the outside system may inform the user wishing to forward the media element of the destination device user's preference, but allowing the user wishing to forward the media element to override this preference.

It should also be understood, that the dispatcher window 62 may also include an area for entering in a physical mailing address of a user. As was explained earlier and shown in FIG. 1, a user can receive a mailer 34 that was printed by a printing device 32 which was connected to a server 30.

Referring back to FIGS. 1, 3, and 9, in step 68, the media element 48 is provided to the dynamic content pipeline for additional processing. Additional details regarding what processing occurs in the dynamic content pipeline will be explained later in this description. Once step 68 has been completed, the media element 48 is delivered to the destination device, as shown in step 70.

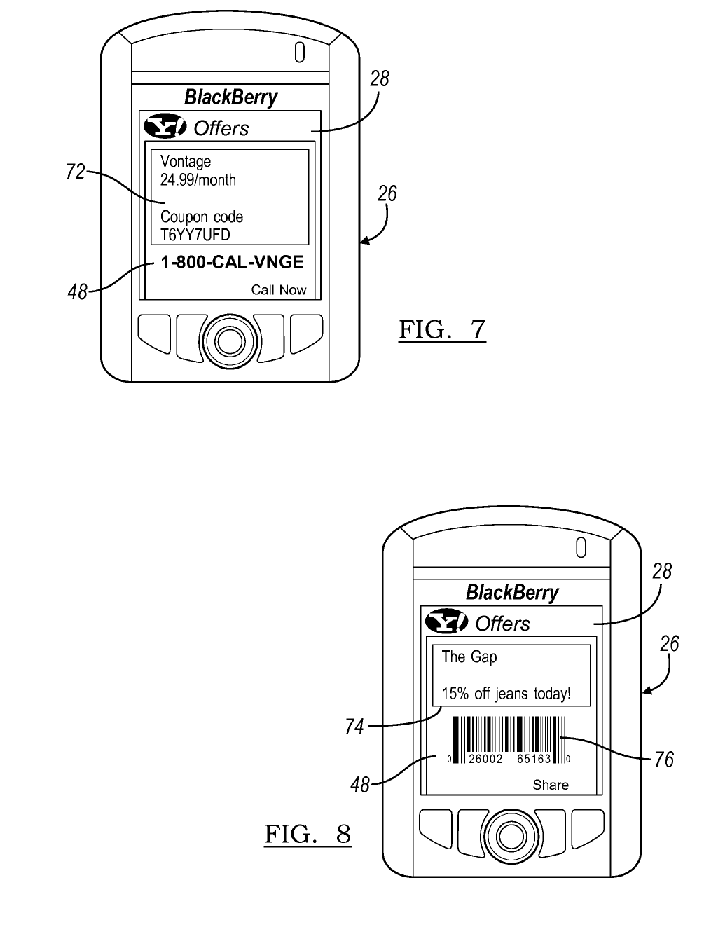

Referring to FIGS. 7 and 8, an example of what the media element looks like when delivered to the destination device 18 is shown. In this example, the destination device is the mobile device 26 of FIG. 1. Here, the display area 28 of the mobile device 26 shows the media element which has been processed by the dynamic content pipeline. In FIG. 7, for example, the media element 48 includes a coupon 72. In FIG. 8, the media element 48 includes a coupon 74 which includes a bar code 76. This bar code 76 can later be scanned in by a retailer so as to better track the whereabouts of the user of the mobile device 26.

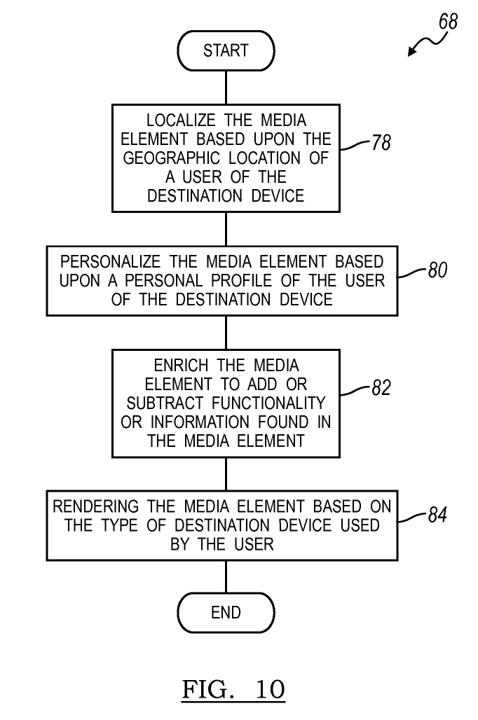

Referring to FIG. 10, a more detailed description of step 68 is shown. As stated previously, step 68 provides the media element 48 to the dynamic content pipeline for additional processing. The following paragraphs will describe the additional processing which occurs in the dynamic content pipeline. It should be understood that steps 78, 80, 82, and 84 are processed in sequential order, so as to create a pipeline. In other words, the steps 78, 80, 82, and 84 form a software pipeline which consists of multiple processes arranged so that the output stream of one process is automatically and promptly fed into the input stream of the next one.

In step 78, the media element is localized based upon the geographic location of a user of the destination device. Generally, if the geographic location of the user of the destination device is known, the media element can be tailored so as to encourage the user to visit one or more known local retailers. Additionally, the media element may contain advertising for a service that is not yet available in the geographic location of the user, in such a case, the media element can be tailored so as to inform the user of this issue.

In step 80, the media element is personalized based upon a personal profile of the user of the destination device. As it is well known, web based service providers, such as Yahoo!, Inc. of Sunnyvale, Calif., are known to keep personal profiles of users. Essentially, in step 80, any information contained in the personal profile of the user may be incorporated into the media element so as to better entice the user to purchase goods or services advertised in the media element 48. Additionally, this step may also relay information back to the web based service provider regarding the media element to be forwarded to the destination device, so as to further enhance the profile of the user. Alternatively or additionally, this information may also be relayed to outside advertisers who place web based advertisements. By so doing, outside advertisers will be able to use this relayed information to better target this, or other users, with advertisements.

In step 82, the media element can be enriched to add or subtract functionality or information found in the media element 48. Generally, the destination device 18 may, or may not be, be capable of certain functions. If the destination device 18 is capable of certain functions, such as animated graphics, the media element 48 may be enriched to include additional functionality, so as to entice the user of the destination device 18 to purchase goods and services advertised in the media element 48.

In step 84, the media element is rendered based upon the type of destination device used by the user. For example, if the destination device 18 is the general purpose computer 22, the media element 48 may be sized and shaped differently than if the media element is displayed on a much smaller display area 28 of the mobile device 26.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

1. A method for providing information via a dynamic content pipeline, the method comprising:
displaying a media element on a display device of a computer;
displaying a dispatcher link on the display device of the computer;
displaying a dispatcher window on the display device of the computer when the dispatcher link is selected;
wherein the dispatcher window has a destination input area, the destination input area being configured to receive a destination identifier, the destination identifier providing the location of a destination device;
providing the media element to the dynamic content pipeline for additional processing; and
delivering the media element to the destination device after the media element has received additional processing from the dynamic content pipeline.

2. The method of claim 1, wherein the media element is an internet advertisement.

3. The method of claim 2, wherein the internet advertisement is at least one of a banner advertisement, or a sequential media advertisement.

4. The method of claim 1, wherein additional processing further comprises the step of:
localizing the media element based upon the geographic location of a user of the destination device;
personalizing the media element based upon a personal profile of the user of the destination device;
enriching the media element to add or subtract functionality or information found in the media element based upon at least one of the personal profile of the user of the destination device, the geographic location of the user of the destination device, or the type of destination device used by the user; and
rendering the media element based on the type of destination device used by the user.

5. The method of claim 4, wherein the step of localizing includes the step of adding local merchant information to the media element.

6. The method of claim 4, wherein the step of enriching includes relaying information relating to the media element to at least one of a web based service provider or a third party advertiser.

7. The method of claim 1, wherein the destination device is at least one of an electronic mail account, a mobile phone, a physical mail address, a navigation system for an automobile or a smart appliance.

8. The method of claim 1, wherein the destination device is an online collection accessible though an internet web page.

9. The method of claim 1, wherein the media element is an audio file and the destination device is a portable media player capable of playing the audio file.

10. The method of claim 1, wherein the destination device is an internet protocol television set top device connected to a television, the set top device configured to display the media element on the television.

11. The method of claim 1, further comprising the step of transmitting a personal profile of the user of the destination device to a party sponsoring the media element.

12. A system for providing information via a dynamic content pipeline, the system comprising:
a processor having instructions;
a network interface in communication with the processor;
the instructions configuring the processor to display a media element on a display device of a computer, display a dispatcher link on the display device of the computer, display a dispatcher window on the display device of the computer when the dispatcher link is selected, wherein the dispatcher window has a destination input area, the destination input area being configured to receive a destination identifier, the destination identifier providing the location of a destination device, provide the media element to the dynamic content pipeline for additional processing, and deliver the media element to the destination device after the media element has received additional processing from the dynamic content pipeline.

13. The system of claim 12, wherein the media element is an internet advertisement.

14. The system of claim 13, wherein the internet advertisement is at least one of a banner advertisement, or a sequential media advertisement.

15. The system of claim 12, wherein additional processing further comprises: localizing the media element based upon the geographic location of a user of
the destination device;
personalizing the media element based upon a personal profile of the user of the destination device;
enriching the media element to add or subtract functionality or information found in the media element based upon at least one of the personal profile of the user of the destination device, the geographic location of the user of the destination device, or the type of destination device used by the user; and
rendering the media element based on the type of destination device used by the user.

16. The system of claim 15, wherein the step of localizing includes the step of adding local merchant information to the media element.

17. The system of claim 15, wherein the step of enriching includes relaying information relating to the media element to at least one of a web based service provider or a third party advertiser.

18. The system of claim 12, wherein the destination device is at least one of an electronic mail account, a mobile phone, a physical mail address, a navigation system for an automobile or a smart appliance.

19. The system of claim 12, wherein the destination device is an online collection accessible though an internet web page.

20. The system of claim 12, wherein the media element is an audio file and the destination device is a portable media player capable of playing the audio file.

21. The system of claim 14, wherein the destination device is an internet protocol television set top device connected to a television, the set top device configured to display the media element on the television.

22. The system of claim 12, wherein the instructions further configure the processor to transmit a personal profile of the user of the destination device to a party sponsoring the media element.
